(19) United States
(12) Patent Application Publication
(10) Pub. No.: US 2013/0169171 A1
(43) Pub. Date: Jul. 4, 2013

(54) LIGHT EMISSION DRIVER DEVICE

(71) Applicant: DENSO CORPORATION, Kariya-city (JP)

(72) Inventors: Tsutomu KAMIZONO, Nagoya-city (JP); Takahito NISHII, Nagoya-city (JP); Daisuke NISHITANI, Kariya-city (JP); Takahiro NAKANO, Kariya-city (JP)

(73) Assignee: DENSO CORPORATION, Kariya-city (JP)

(21) Appl. No.: 13/662,904

(22) Filed: Oct. 29, 2012

(30) Foreign Application Priority Data
Dec. 28, 2011 (JP) 2011-288058

(51) Int. Cl. H05B 37/02

(52) U.S. Cl. 315/185 R

(57) ABSTRACT

A light emission driving device includes a shunt resistor, a driver circuit and a correction circuit. The shunt resistor converts a magnitude of a driving current flowing in a LED group into a voltage value. The driver circuit 5 controls a voltage supplied to a light-emitting module so that a voltage detected by the shunt resistor equals a preset target voltage. The correction circuit retrieves a resistance value of a current identification resistor and corrects the magnitude of the driving current flowing in the LED group based on the retrieved resistance value. The correction circuit generates the correction current of the magnitude corresponding to the retrieved resistance value and supplies the correction current to a junction between the LED group and the shunt resistor.

### CROSS REFERENCE TO RELATED APPLICATION

The present application relates to and incorporates herein by reference Japanese patent application No. 2011-288058 filed on Dec. 28, 2011.

### TECHNICAL FIELD

The present disclosure relates to a light emission driver device for driving a light-emitting source, which varies its light quantity in accordance with a magnitude of a driving current supplied thereto.

### BACKGROUND ART

A recent vehicular light uses, as a light source, a light-emitting module, in which a plurality of light-emitting diodes (LED) is connected in series. This light-emitting module is driven by a constant current (for example, JP 2003-187614A corresponding to US 2003/0117088 A1).

A characteristic of light quantity relative to driving current (referred to as a light emission characteristic below) varies from module to module. For this reason, the light emission characteristic is ranked, that is, classified in different ranks, and resistors having resistances corresponding to such ranks (that is, BIN resistors) are provided so that the resistance of the BIN resistor is electrically readable.

A relation between a rank of light-emitting characteristic and a resistance of a BIN resistor is preset. For example, as exemplified in a table shown in FIG. 9, the light-emitting characteristic is ranked in five levels (rank 1 to rank 5) based on a magnitude of a driving current If [mA] required to provide a prescribed light quantity. That is, even when a driving current of the same magnitude is supplied to light-emitting modules, the emitted light quantities vary among modules of different ranks.

A LED driver circuit, which is formed in a semiconductor integrated circuit (IC), is used as a driving circuit for driving the module by the constant current. This driver circuit is configured to detect a current value flowing in a light-emitting module by converting it to a voltage value by way of a shunt resistor, and controls a voltage value supplied to the light-emitting module so that the detected voltage value equals a preset target voltage.

For a vehicular light, a light-emitting module need be so designed that its light quantity is within a prescribed range. For this purpose, a shunt resistor need be selected so that its inter-terminal voltage (that is, voltage developed by the resistor) equals a target voltage when a driving current If prescribed by a rank flows.

If a resistance value of the shunt resistor is fixed for mass production of a light emission driving device for the vehicular light, it is necessary to select a light-emitting module having a characteristic (rank), which emits light quantity within a prescribed range relative to the fixed shunt resistor, or form a light emission driving device, which has a resistance of a shunt resistor corresponding to a rank of a used light-emitting module. As a result, work load and costs for manufacture are increased.

It is proposed to configure a light emission driving device so that a plurality of shunt resistors of different resistance values are connected in parallel and either one of the shunt resistors is selected in correspondence to a used light-emitting module. This light emission driving device can be used in common for a plurality of ranks.

However, a switch, which selects the shunt resistor, has a resistance component (for example, on-resistance of a transistor). The on-resistance of the transistor affects a voltage detected by the shunt resistor and decreases accuracy of the detected voltage. As a result accuracy of controlling a light quantity at a constant level is lowered.

Since particularly the shunt resistor is provided in series in a current flow path of a driving current, a resistance value of the shunt resistor need be small. As a result, the resistance component of the switch becomes very influential.

### SUMMARY

It is therefore an object to provide a light emission driving device, which is capable of accurately controlling a light quantity at a constant value relative to a plural types of light-emitting modules of different ranks.

A light emission driving device is provided for a light-emitting module, which includes a light-emitting part and an information storing part. The light-emitting part varies a light quantity in correspondence to a magnitude of a driving current supplied thereto. The information storing part stores identification information, which is provided to indicate a light-emitting characteristic of the light-emitting part and electrically detectable. The light emission driving device includes a current detection part, a constant current driving part, an identification information detection part, a correction value storing part and a correction part. The current detection part is connected in series with the light-emitting part. The constant current driving part drives the light-emitting part by a constant current so that a detected voltage outputted by the current detecting resistor equals a preset target voltage. The identification information detection part electrically detects the identification information from the information storing part. The correction value storing part stores a plurality of correction values provided in correspondence to a plurality of identification information. The correction part corrects a magnitude of the driving current flowing in the light-emitting part in accordance with the correction value retrieved from the correction value storing part by using the identification information detected by the identification information detection part.

In one aspect of the light emission driving device, a correction resistor is further provided for applying the detected voltage to the constant current driving part, and the correction part supplies the correction current to one end of the correction resistor, which is at a side of the constant current driving part.

In another aspect of the light emission driving device, the correction part is configured to generate a correction voltage corresponding to the correction value, and the constant current driving part is configured to generate the target voltage from the correction voltage.

### BRIEF DESCRIPTION OF THE DRAWINGS

The above and other objects, features and advantages of a light emission driving device will become more apparent from the following description made with reference to the accompanying drawings. In the drawings:

FIG. 1 is a circuit diagram of a vehicular lamp device including a light emission driving device according to a first embodiment;

FIG. 2 is a block diagram showing a correction current generation circuit provided in the first embodiment;

FIGS. 3A, 3B and 3C are circuit diagrams of variations of the correction current generation circuit provided in the first embodiment;

FIGS. 4A and 4B are circuit diagrams of a variation of the vehicular lamp device according to the first embodiment;

FIG. 5 is a circuit diagram of a vehicular lamp device including a light emission driving device according to a second embodiment;

FIGS. 6A, 6B and 6C are circuit diagrams of examples of a correction voltage generation circuit provided in the second embodiment;

FIG. 7 is a circuit diagram of a vehicular lamp device including a light emission driving device according to a third embodiment;

FIGS. 8A and 8B are circuit diagrams of examples of a correction voltage generation circuit provided in the third embodiment; and

FIG. 9 is an illustration of an example of a relation between ranks of a light-emitting characteristic of a light-emitting module and resistance values of a BIN resistor.

### DETAILED DESCRIPTION OF THE EMBODIMENT

A light emission driving device will be described below with reference to embodiments shown in the drawings.

### First Embodiment

<Overall Configuration>

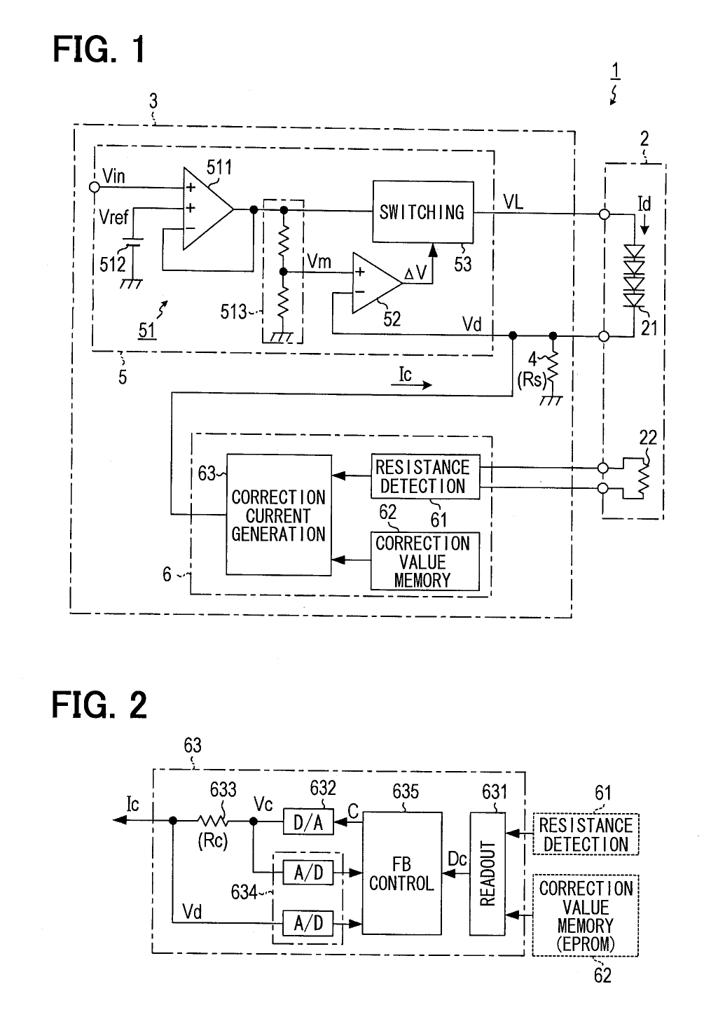

Referring to FIG. 1, a vehicular lamp device 1 is formed of a light-emitting module 2 and a light emission driving device 3, which drives the light-emitting module 2 to emit a constant quantity.

The light-emitting module 2 includes a plurality of series-connected light-emitting diodes (referred to as a LED group below) 21 and a current identification resistor (BIN resistor) 22 having a resistance value corresponding to a rank of light emission characteristic of the LED group 21.

The light emission driving device 3 includes a shunt resistor 4, a driver circuit 5 and a correction circuit 6. The shunt resistor 4 is connected in series with the LED group 21 and proportionally converts a magnitude of a driving current Id supplied to the LED group 21 into a voltage value. The driver circuit 5 controls a voltage VL supplied to the light-emitting module 2 so that a voltage Vd detected by the shunt resistor 4 equals a preset target voltage Vm. The correction circuit 6 retrieves a resistance value of the current identification resistor 22 and corrects a magnitude of the driving current Id flowing to the LED group 21 in accordance with the retrieved resistance value.

<Driver Circuit>

The driver circuit 5 includes a target voltage generation circuit 51, an error signal generation circuit 52 and a switching circuit 53. The target voltage generation circuit 51 generates a target voltage Vm. The error signal generation circuit 52 generates an error signal ΔV indicative of a difference between the target voltage Vm generated by the target voltage generation circuit 51 and the detected voltage Vd. The switching circuit 53 includes a DC-DC converter (not shown) and controls the supply voltage VL to increase and decrease so that the error signal ΔV becomes zero.

The target voltage generation circuit 51 includes an operational amplifier (error amplifier) 511, a voltage generation source 512 and a voltage divider circuit 513. The operational amplifier 511 has one inverting input terminal (−) and a plurality of non-inverting input terminals (+) and operates by using the smallest one of the voltages among the non-inverting input terminals as a non-inverting input voltage. The voltage generation source 512 generates a stabilized reference voltage Vref (for example, 1.0 V) by using a gap voltage of a semiconductor or the like. The voltage divider circuit 513 generates the target voltage Vm by proportionally dividing an output voltage of the operational amplifier 511.

The operational amplifier 511 forms a voltage follower circuit, which outputs the non-inverting input inter-terminal voltage itself with its output terminal and the non-inverting input terminal being connected directly. The voltage generation source 512 is connected to one of the non-inverting input terminals and another one of the non-inverting input terminals is connected to an external input terminal. The external input terminal is pulled up (not shown). That is, the target voltage generation circuit 51 is so configured to output, as the target voltage Vm, a voltage produced by dividing the reference voltage Vref of the voltage generation source 512 when no voltage is inputted from the external input terminal. The target voltage generation circuit 51 is further configured to output, as the target voltage Vm, a voltage produced by dividing an external voltage Vin when the external voltage Vin applied to the external input terminal is smaller than the reference voltage Vref.

The error signal generation circuit 52 is formed of an operational amplifier, which is configured to receive the target voltage Vm at its non-inverting input terminal (+) and the detected voltage Vd at its inverting input terminal (−). That is, the error signal ΔV generated by the error signal generation circuit 52 is negative and positive when the detected voltage Vd is larger and smaller than the target voltage Vm, respectively. The switching circuit 53 operates in accordance with the error signal ΔV to decrease and increase the supply voltage VL when the error signal ΔV is negative and positive, that is, when the detected voltage Vd is larger and smaller than the target voltage Vm, respectively.

<Correction Circuit>

The correction circuit 6 includes a resistance value detection circuit 61, a correction value memory circuit 62 and a correction current generation circuit 63. The resistance value detection circuit 61 electrically detects a resistance value of the current identification resistor 22 thereby to retrieve or read out a rank of the light-emitting module 2. The correction value memory circuit 62 stores correction values in correspondence to the resistance values of the resistor 22 (that is, rank of the light-emitting module 2). The correction values are used to correct the driving current Id supplied to the LED group 21. The correction current generation circuit 63 generates the correction current Ic in correspondence to the correction value. The correction current Ic generated by the correction current generation circuit 63 is supplied to a junction between the shunt resistor 4 and the light-emitting module 2.

The resistance value detection circuit 61 is configured to A/D convert, by an A/D converter (not shown), the inter-terminal voltage of the current identification resistor 22, which is generated when the constant current is supplied to the current identification resistor 22. The correction value memory circuit 62 is formed of a semiconductor memory (for example, EPROM and the like), which is capable of holding its storage contents even when power supply is interrupted and rewritable of storage contents.

The correction current generation circuit 63 of the correction circuit 6 is configured in detail as shown in FIG. 2. The correction current generation circuit 63 includes a readout circuit 631, a D/A converter 632, a current conversion resistor 633, an A/D conversion circuit 634 and a FB control circuit 635. The readout circuit 631 reads out or retrieves a correction value Dc from the correction value memory circuit 62 corresponding to the resistance value detected by the detection circuit 61, which detects the rank of the LED group 21. The D/A converter 632 generates the correction voltage Vc in accordance with a command value C. The current conversion resistor 633 generates the correction current Ic corresponding to the correction voltage Vc. The A/D conversion circuit 634 is formed of a pair of A/D converters for detecting an inter-terminal voltage of the current conversion resistor 633. The FB control circuit 635 feedback-controls the command value C (correction voltage Vc or correction current Ic) so that the inter-terminal voltage of the current conversion resistor 633 detected by the A/D conversion circuit 634 equals the correction value Dc. The correction value Dc is expressed as a voltage value. The correction current Ic is thus controlled to a constant value (Ic=Dc/Rc) determined by the correction voltage Dc and the current conversion resistor 633.

The readout circuit 631 and the FB control circuit 635 may be realized by a hardware sequencer or software processing executed by a microcomputer. It is assumed in the following description that the polarities of the correction currents Ic flowing out from the correction current generation circuit 63 and flowing in the correction current generation circuit 63 are positive and negative, respectively.

<Correction Value Setting Operation>

In the vehicular lamp device 1 configured as described above, the correction value Dc is stored in the correction value memory circuit 62 at the time of manufacture. In this storing work, the vehicular lamp device 1 and all ranks (rank-1 to rank 5) of light-emitting modules 2 are used.

In a correction value setting work, the light emission driving device 3 is operated by setting the correction voltage Vc (Vc←Vm) so that the correction value Ic becomes zero. At this time, the magnitude of the driving current Id flowing to the LED group 21 is measured by using an external current measuring instrument.

In the light-emitting module 2, which is the subject of measurement, a typical value of the driving current required to provide a desired light quantity (for example, a center value of a range of the driving currents belonging to the rank) is set as a correction target value If. Then a differential current ΔI (=Ic−If) between the measured value of the driving current Id and the correction target value If is calculated.

As far as the differential current ΔI is not equal to nor less than a preset allowable value, the correction voltage Vc(←Vc+R·ΔI) is set again so that the differential current ΔI flows as the correction current Ic. By operating the light emission driving device 3 again by this correction voltage, the magnitude of the driving current Id flowing in the LED group 21 is measured.

The above-described processing is repeated by using the measurement results. When the differential current ΔI becomes equal to or smaller than the allowable value, the inter-terminal voltage of the current conversion resistor 633 detected by the A/D conversion circuit 634 is set as the correction value Dc for the rank, which is the subject of measurement.

This measurement is repeated for each of light-emitting modules 2 of different ranks. The correction value Dc thus determined with respect to each rank is stored in the correction value memory circuit 62. That is, the correction value Dc is set so that the difference from the correction target value If required to emit the desired light quantity is compensated by the correction current Ic.

<Advantage>

According to the vehicular lamp device 1 configured as described above, the correction value Dc corresponding to the resistance value (that is, rank of the light-emitting characteristic of the light-emitting module 2) detected by the resistance value detection circuit 61 is retrieved form the correction value memory circuit 62. The correction voltage Vc is generated so that the inter-terminal voltage of the current conversion resistor 633 generated in response to the correction current Ic equals the retrieved correction value Dc. The correction current Ic (=Dc/Rc) is thus supplied as desired in correspondence to the correction value Dc.

When the correction current Ic is zero, the driving current Id flowing in the light-emitting module 2 becomes a current value (=Vm/Rs) determined by the target voltage Vm and the resistance Rs of the shunt resistor 4. When the correction current Ic of the positive polarity is supplied, the driving current Id decreases correspondingly by such an amount of the correction current Ic. When the correction current Ic of the negative polarity is supplied, the driving current Id increases correspondingly by such an amount of the correction current Ic.

According to the vehicular lamp device 1, therefore, it is possible to compensate the driving current Id so that the desired quantity of light is provided by the correction current Ic even in a case that the shunt resistor 4 does not have a resistance value suitable for the rank of the light-emitting module 2.

With only one type of the light emission driving device 3, plural types of light-emitting modules 2 of different ranks can be driven to emit the desired light quantity.

In the first embodiment, the shunt resistor 4 operates as a current detection part, the driver circuit 5 operates as a constant current driving part, the resistance value detection circuit 61 operates as an identification information detection part, the correction value memory circuit 62 operates as a correction value memory part, the correction current generation circuit 63 operates as a correction part. The correction current generation circuit 631, the FB control circuit 635, the D/A converter 632 and the A/D conversion circuit 634 operate as a correction voltage generation part.

<Variation>

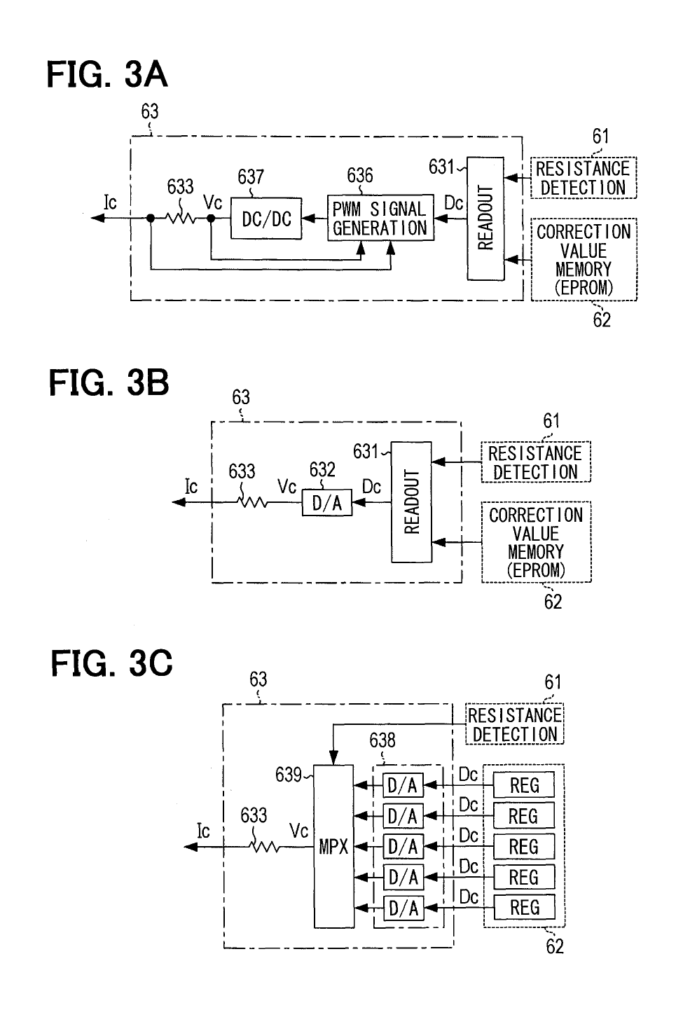

In the first embodiment, the correction current generation circuit 63 generates the correction voltage Vc by the D/A converter 632, the A/D conversion circuit 634 and the FB control circuit 635. Alternatively, as shown in FIG. 3A, the correction voltage Vc corresponding to the correction value Dc may be generated by a PWM signal generation circuit 636 and a conventional DC-DC converter 637. The PWM signal generation circuit 636 generates a PWM signal corresponding to the correction value Dc. The DC-DC converter 637 generates a present DC voltage by a switching operation performed in response to the PWM signal generated by the PWM signal generation circuit 636. The PWM signal generation circuit 636 may be configured to increase and decrease a duty ratio of the PWM signal so that the inter-terminal voltage of the current conversion resistor 633 equals the correction value Dc.

In the first embodiment, the correction current generation circuit 63 feedback-controls the correction voltage Vc. Alternatively, as shown in FIG. 3B, the correction value Dc retrieved by the readout circuit 631 may be directly used as the command value C for generating the correction voltage Vc without provision of the A/D conversion circuit 634 and the FB control circuit 635.

Further, as shown in FIG. 3C, the correction value memory circuit 62 may be formed of registers provided rank by rank. The correction current generation circuit 63 may be formed of a D/A converter group 638, a multiplexer 639 and a current conversion resistor 633. The D/A converter group 638 generates the correction voltage Vc individually in correspondence to the registered value (correction value Dc) of each register. The multiplexer 639 selects, based on the resistance value retrieved by the resistance value detection circuit 61, one of the correction values Vc converted by the D/A converter group 638. The current conversion resistor 633 generates the correction current Ic corresponding to the correction voltage Vc selected by the multiplexer 639.

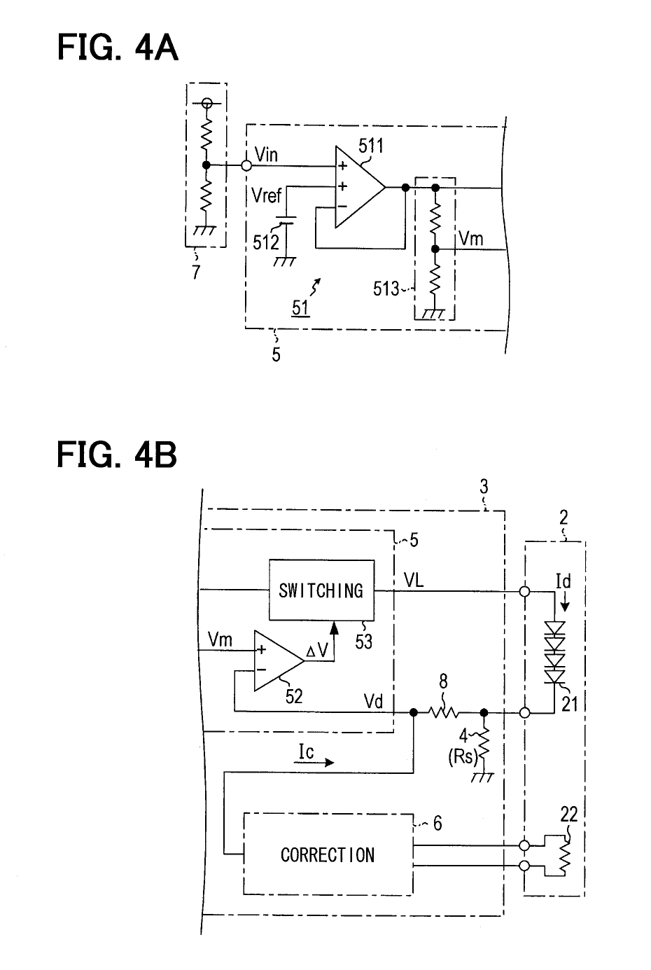

In the first embodiment, the target voltage Vm is generated based on the reference voltage Vref generated by the voltage generation source 512. Alternatively, as shown in FIG. 4A, the external voltage Vin smaller than the reference voltage Vref may be applied to the external input terminal by a voltage divider circuit 7, which divides a power supply voltage, so that the target voltage Vm may be generated based on the external voltage Vin in place of the reference voltage Vref.

In the first embodiment, the correction current Ic is supplied to a junction point between the shunt resistor 4 and the light-emitting module 2. Alternatively, as shown in FIG. 4B, the detected voltage Vd may be supplied to the driver circuit 5 through a correction resistor 8 and the correction current Ic may be supplied to one end point of the correction resistor 8, which is on the driver circuit 5 side, that is at an output side of the resistor 8. According to this variation, ability of correction by the correction current Ic can be increased.

### Second Embodiment

<Overall Configuration>

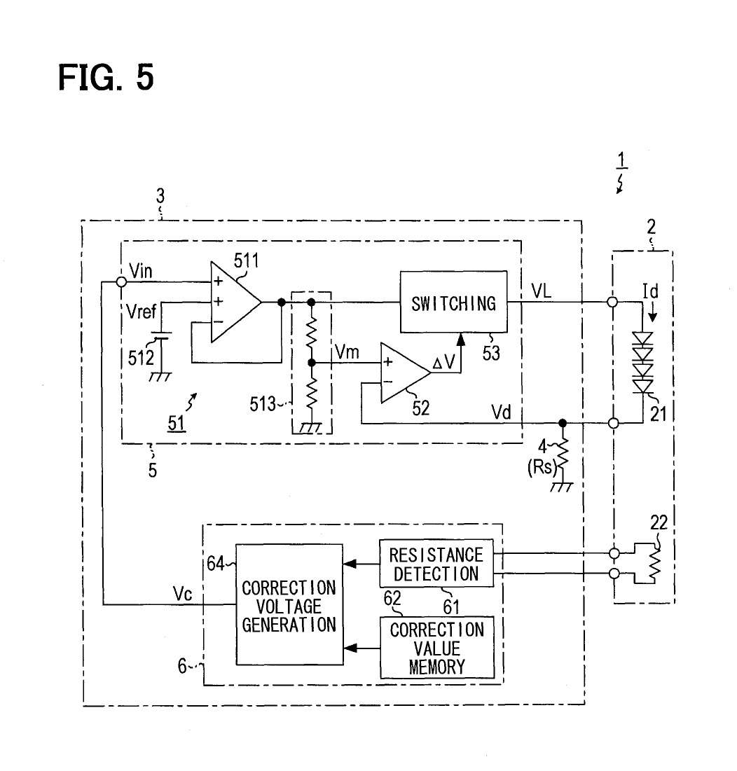

According to a second embodiment, as shown in FIG. 5, the vehicular lamp device 1 is different from that of the first embodiment only in respect of the configuration of the driving device 3, particularly the configuration of the correction circuit 6, and the subject of correction performed by the correction circuit 6. The following description will be made about these differences.

<Correction Circuit>

The correction circuit 6 includes the resistance value detection circuit 61 and the correction value memory circuit 62, which are configured similarly as in the first embodiment. The correction circuit 6 further includes, in place of the correction current generation circuit 63, a correction voltage generation circuit 64, which generates the correction voltage Vc corresponding to the correction value Dc. The correction voltage Vc generated by the correction voltage generation circuit 64 is applied to the external input terminal of the light emission driving device 3 as the external voltage Vin.

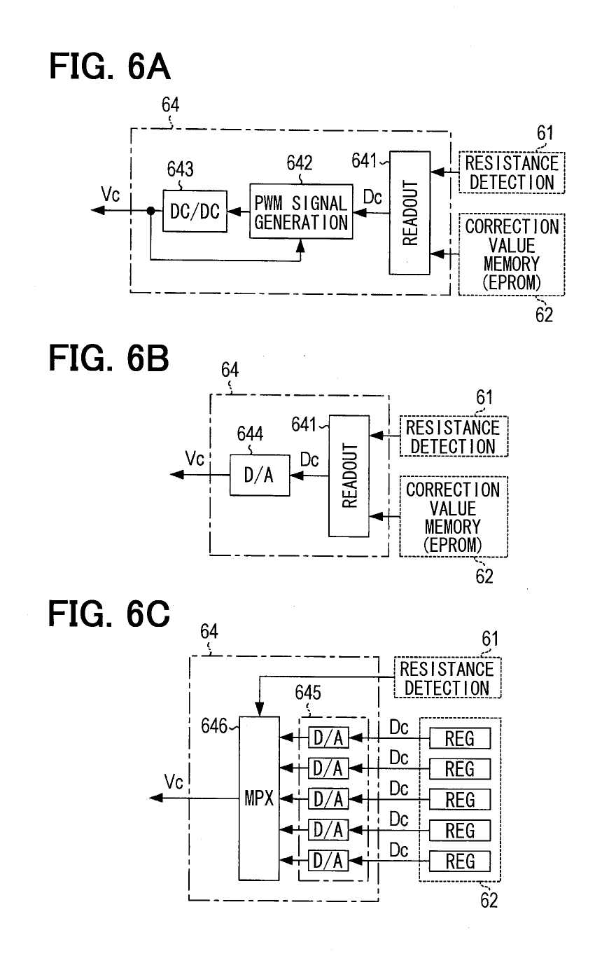

As shown in FIG. 6A, the correction voltage generation circuit 64 has a configuration, in which the current conversion resistor 633 is removed from the variation example of the correction current generation circuit 63 shown in FIG. 3A. That is, the correction voltage generation circuit 64 is formed of a readout circuit 641, a PWM circuit 642 and a DC-DC converter 634. The PWM signal generation circuit 642 is configured to control the duty of the PWM signal to increase and decrease so that the correction voltage Vc, which is an output voltage of the DC-DC converter 634, equals the correction value Dc.

<Correction Value Setting Work>

In the vehicular lamp device 1 according to the second embodiment, the correction value Dc is stored in the correction value memory circuit 62 as in the case of the first embodiment.

The resistance value of the shunt resistor 4 is set to a value suitable for a rank (rank 5 in FIG. 9), which requires the largest current to emit the prescribed light quantity, among the ranks of the light-emitting modules 2.

In the correction value setting work, the correction value Dc is initially set so that the correction value Vc (>Vref), which invalidates the external voltage Vin, is generated. The light emission driving device 3 is then driven and the magnitude of the driving current Id flowing in the LED group 21 at this time is measured by using an external current measuring instrument.

In the light-emitting module 2, which is the subject of measurement, a typical value of the driving current required to emit the desired light quantity (for example, the center value of the range of the driving currents belonging to the rank) is set as the correction target value If. When the measured value of the driving current Id is not equal to the correction target value If (that is, the driving current Id is larger), the correction value Dc is set again so that the correction voltage Vc generated by the correction current generation circuit 63 decreases. The similar processing is repeated until the measured value of the driving current Id becomes equal to the correction target value If (until the difference between the two becomes equal to or smaller than an allowable value).

When the measured value of the driving current Id becomes equal to the correction target value If, the correction value Dc at this time is set as the correction value Dc for the rank, which is the subject of measurement. This measurement is repeated for the light-emitting module 2 of each rank. The correction value Dc thus determined with respect to each rank is stored in the correction value memory circuit 62.

That is, the correction value Dc is set so that the target voltage Vm, which causes the correction target value If to flow to emit the desired light quantity, is generated by the target voltage generation circuit 51.

<Advantage>

According to the vehicular lamp device is configured as described above, the correction value Dc corresponding to the resistance value (that is, rank of the light-emitting characteristic of the light-emitting module 2) retrieved by the resistance value detection circuit 61 is retrieved from the correction value memory circuit 62. By the correction voltage Vc generated in correspondence to the correction value, the target voltage Vm in the light emission driving device 3 is corrected so that the driving current Id is supplied to the light-emitting module 2 to cause the light-emitting module 2 to emit the desired light quantity.

According to the vehicular lamp device 1, therefore, it is possible to correct the target voltage Vm by the correction voltage Vc to emit the desired light quantity even in a case that the shunt resistor 4 does not have a resistance value suitable for the rank of the light-emitting module 2.

With only one type of the light emission driving device 3, plural types of light-emitting modules 2 of different ranks can be driven to emit the desired light quantity. In the second embodiment, the correction voltage generation circuit 64 operates as the correction part.

<Variation>

In the second embodiment, the correction voltage generation circuit 64 is formed of the readout circuit 641, the PWM signal generation circuit 642 and the DC-DC converter 643. However, the correction voltage generation circuit 64 is not limited to such a configuration.

For example, as shown in FIG. 6B, the correction voltage generation circuit 64 may be formed of the readout circuit 641 and a D/A converter 644 by removing the current conversion resistor 633 from the variation example of the correction current generation circuit 63 shown in FIG. 3B.

Further, as shown in FIG. 6C, the correction voltage generation circuit 64 may be formed of the D/A converter group 645 and the multiplexer 646 by removing the current conversion resistor 633 from the variation example of the correction current generation circuit 63 shown in FIG. 3C.

### Third Embodiment

<Overall Configuration>

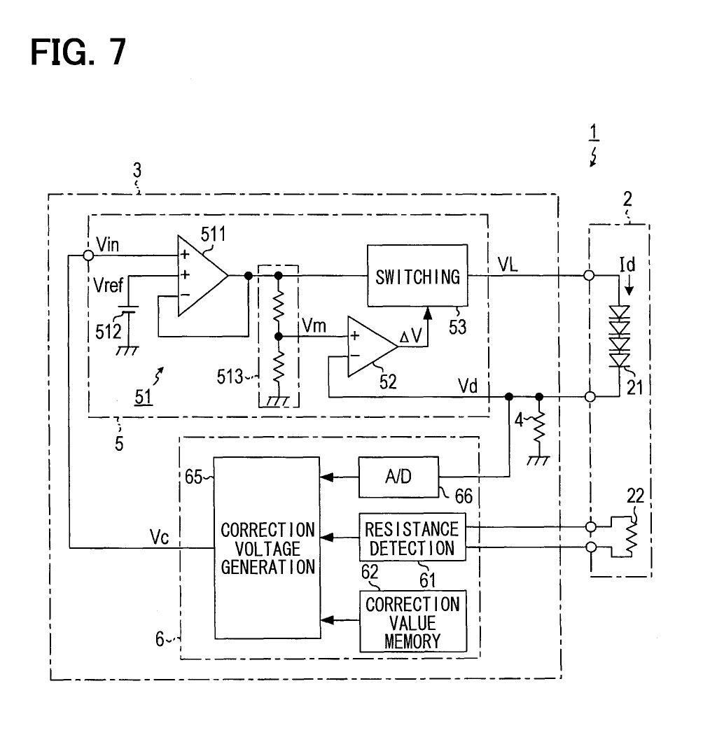

According to a third embodiment, as shown in FIG. 7, the vehicular lamp device 1 is different from that of the second embodiment only in respect of the configuration of the driving device 3, particularly the configuration of the correction circuit 6.

<Correction Circuit>

The correction circuit 6 includes the resistance value detection circuit 61 and the correction value memory circuit 62. The correction circuit 6 further includes, an A/D converter 66, which A/D-converts the detected voltage Vd, and a correction voltage generation part 65, which generates the correction voltage Vc so that the A/D-converted value (referred to as a monitor value below) equals the correction value Dc.

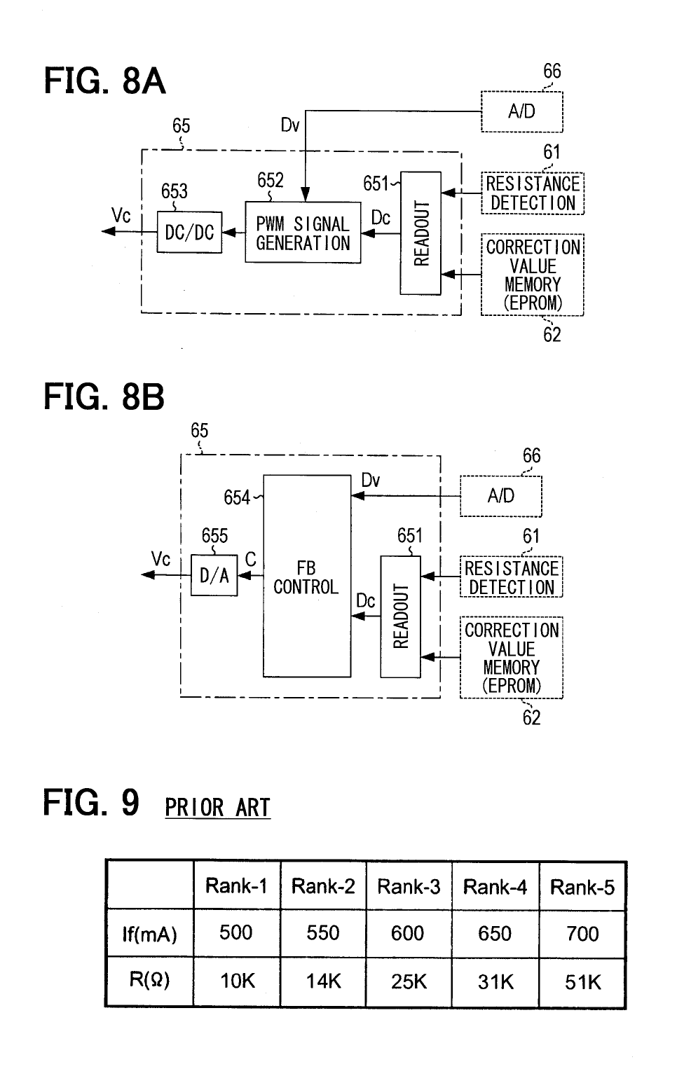

As shown in FIG. 8A, similarly to the correction voltage generation circuit 64 shown in FIG. 6B, the correction voltage generation part 65 is formed of a readout circuit 651, a PWM circuit 652 and a DC-DC converter 653. The PWM signal generation circuit 652 is configured to control the duty of the PWM signal to increase and decrease so that the monitored value Dv outputted from the A/D converter 66 equals the correction value Dc.

<Correction Value Setting Work>

In the correction value setting work, measurement is performed in the similar manner as in the vehicular lamp device 1 according to the second embodiment. It is noted however that the monitored value Dv detected by the A/D converter 66 is used as the correction value Dc of the rank, which is a subject of measurement, when the measured value of the driving current Id equals the correction target value If.

This measurement is repeated for the light-emitting module 2 of each rank. The correction value Dc thus determined with respect to each rank is stored in the correction value memory circuit 62.

<Advantage>

According to the third embodiment, the correction value Dc corresponding to the resistance value (that is, rank of the light-emitting characteristic of the light-emitting module 2) Rc detected by the resistance value detection circuit 61 is retrieved from the correction value memory circuit 62. The correction voltage Vc is feedback-controlled so that the monitored value Dv equals the correction value Dc. The target voltage Vm in the light emission driving device 3 is corrected so that the driving current Id is supplied to the light-emitting module 2 to cause the light-emitting module 2 to emit the desired light quantity.

Therefore, it is possible to provide the similar advantage as provided in the second embodiment. It is also possible to correct the target voltage Vm to emit the desired light quantity even in a case that the condition of the driver circuit 5 is changed.

In the third embodiment, the correction voltage generation circuit 65 operates as the correction part.

<Variation>

In the third embodiment, the correction voltage generation circuit 65 is formed of the readout circuit 651, the PWM signal generation circuit 652 and the DC-DC converter 653. However, the correction voltage generation circuit 65 is not limited to such a configuration.

For example, as shown in FIG. 8B, the correction voltage generation circuit 65 may be formed of the readout circuit 651, a D/A converter 655, and a FB control circuit 654. The readout circuit 651 reads out the correction value Dc from the correction value memory circuit 62 in correspondence to the resistance value, which is detected by the resistance value detection circuit 61. The D/A converter 655 generates the correction voltage Vc in correspondence to the command value C. The FB control circuit 654 feedback-controls the command value C (correction value Vc or target voltage Vm) so that the monitored value Dv of the A/D converter 66 equals the correction value Dc.

What is claimed is:

1. A light emission driving device for a light-emitting module, which includes a light-emitting part and an information storing part, the light-emitting part varying a light quantity in correspondence to a magnitude of a driving current supplied thereto, and the information storing part storing identification information, which is provided to indicate a light-emitting characteristic of the light-emitting part and electrically detectable, the light emission driving device comprising:
a current detection part connected in series with the light-emitting part;
a constant current driving part for driving the light-emitting part by a constant current so that a detected voltage outputted by the current detecting resistor equals a preset target voltage;
an identification information detection part for electrically detecting the identification information from the information storing part;
a correction value storing part storing a plurality of correction values provided in correspondence to a plurality of identification information; and
a correction part for correcting a magnitude of the driving current flowing in the light-emitting part in accordance with the correction value retrieved from the correction value storing part by using the identification information detected by the identification information detection part,
wherein the correction part is configured to generate a correction current corresponding to the correction value and supplies the correction current to a junction point between the light-emitting part and the current detection part.

2. The light emission driving device according to claim 1, further comprising:
a correction resistor for applying the detected voltage to the constant current driving part,
wherein the correction part supplies the correction current to one end of the correction resistor, which is at a side of the constant current driving part.

3. The light emission driving device according to claim 1, wherein the correction part includes:
a correction voltage generation circuit for generating a correction voltage corresponding to the correction value; and
a current conversion resistor having one end for receiving the correction voltage and another end connected to a point of supply of the correction current, the current conversion resistor generating the correction current corresponding to the correction voltage.

4. The light emission driving device according to claim 3, wherein:
the correction voltage generation part feedback-controls the correction voltage so that an inter-terminal voltage of the current conversion resistor corresponds to the correction value.

5. A light emission driving device for a light-emitting module, which includes a light-emitting part and an information storing part, the light-emitting part varying a light quantity in correspondence to a magnitude of a driving current supplied thereto, and the information storing part storing identification information, which is provided to indicate a light-emitting characteristic of the light-emitting part and electrically detectable, the light emission driving device comprising:
a current detection part connected in series with the light-emitting part;
a constant current driving part for driving the light-emitting part by a constant current so that a detected voltage outputted by the current detecting resistor equals a preset target voltage;
an identification information detection part for electrically detecting the identification information from the information storing part;
a correction value storing part storing a plurality of correction values provided in correspondence to a plurality of identification information; and
a correction part for correcting a magnitude of the driving current flowing in the light-emitting part in accordance with the correction value retrieved from the correction value storing part by using the identification information detected by the identification information detection part,
wherein the correction part is configured to generate a correction voltage corresponding to the correction value; and
wherein the constant current driving part is configured to generate the target voltage from the correction voltage.

6. The light emission driving device according to claim 5, wherein:
the correction part feedback-controls the correction voltage so that the detected voltage corresponds to the correction value.
